(19) United States
(12) Patent Application Publication
(10) Pub. No.: US 2004/0012187 A1
(43) Pub. Date: Jan. 22, 2004

(54) Seat belt device

(76) Inventor: Wen-yuan Wu, Chang Hua Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/198,155

(22) Filed: Jul. 19, 2002

(51) Int. Cl. B60R 22/00

(52) U.S. Cl. 280/801.1

(57) ABSTRACT

A seat belt device includes a joint, two west belts, a front belt, two shoulder belts and two rear belts. Each of the west belts includes a first end secured to a chassis of a vehicle and a second end for engagement with the joint. The front belt includes a first end secured to the chassis and a second end for engagement with the joint. Each of the shoulder belts includes a first end connected with the first end of the other one of the shoulder belts and a second end for engagement with the joint. Each of the rear belts includes a first end secured to the chassis and a second end connected with the second ends of the shoulder belts.

### BACKGROUND OF INVENTION

1. Field of Invention

The present invention relates to a seat belt device.

2. Related Prior Art

Referring to FIGS. 5˜8, a conventional seat belt device 1 includes two west belts 2, a front belt 3, a rear belt 6, a shoulder belt 7 and a joint 4. The west belts 2 both include a first end and a second end. The first end of each of the west belts 2 is secured to a chassis of a car. Each of the west belts 2 is inserted through a slot defined in a chair 5 of the car so that the second end thereof can be engaged with the joint 4. The front belt 3 includes a first end and a second end. The first end of the front belt 3 is secured to the chassis. The front belt 3 is inserted through a slot defined in the chair 5 so that the second end thereof can be engaged with the joint 4. The rear belt 6 includes a first end secured to the chassis and a second end connected with a middle point of the shoulder belt 7 as best shown in FIG. 6. The rear belt 6 and the shoulder belt 7 make a configuration similar to the alphabet “Y.” The shoulder belt 7 includes two ends each inserted through a slot defined in the chair 5 so that they can be engaged with the joint 4. As shown in FIGS. 6˜8, the rear belt 6 is wound around a length-adjusting element 8. According to regulations by the SFI Foundation Inc., each of the shoulder belts 7 must withstand a tensile force of 2500 pounds, and the real belt 6 must withstand a tensile force of 5000 pounds. When subject to a large tensile force, a considerable frictional force occurs between the rear bolt 6 and the length adjustment ring 8 so as to wear away the belt 6 as best shown in FIG. 8, thus reducing the strength of the belt 6. The belt 6 may finally become too weak to sustain the tensile force. When this happens, a driver could be seriously injured or killed. For example, it is found from the investigation of the accident that killed the famous late racing car driver, Sinar, the seat belt device put on him is fractured.

The present invention is therefore intended to obviate or at least alleviate the problem encountered in prior art.

### SUMMARY OF INVENTION

It is the primary objective of the present invention to provide a seat belt device with double security.

According to the present invention, a seat belt device includes a joint, two west belts, a front belt, two shoulder belts and two rear belts. Each of the west belts includes a first end secured to a chassis of a vehicle and a second end for engagement with the joint. The front belt includes a first end secured to the chassis and a second end for engagement with the joint. Each of the shoulder belts includes a first end connected with the first end of the other one of the shoulder belts and a second end for engagement with the joint. Each of the rear belts includes a first end secured to the chassis and a second end connected with the second ends of the shoulder belts.

The seat belt device may include two length-adjusting elements each connected with one of the rear belts or one length-adjusting element connected with the rear belts.

The seat belt device may include two buckles each connected with one of the rear belts and secured to the chassis or one buckle connected with the rear belts and secured to the chassis.

The buckle may define two slots or only one slot. In the case of two slots, the first end of one of the rear belts is inserted through one of the slots into connection with a portion of the same rear belt, and the first end of the other one of the rear belts is inserted through the slots into connection with a portion of the same rear belt. Otherwise, the single receives the rear belts, and the seat belt device may include only one length-adjusting element connected with the rear belts.

The first end of each of the shoulder belts may be formed integrally with the first end of the other one of the shoulder belts.

The second end of each of the rear belts may be formed integrally with the second end of the other one of the rear belts.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a perspective view of a seat belt device according to a first embodiment of the present invention;

FIG. 2 is a side view of a driver tightly held onto a chair via the seat belt device according to the first embodiment of the present invention;

FIG. 3 is a perspective view of a seat belt device according to a second embodiment of the present invention;

FIG. 4 is a perspective view of a seat belt device according to a third embodiment of the present invention;

FIG. 5 is a perspective view of a chair and a seat belt device according to prior art;

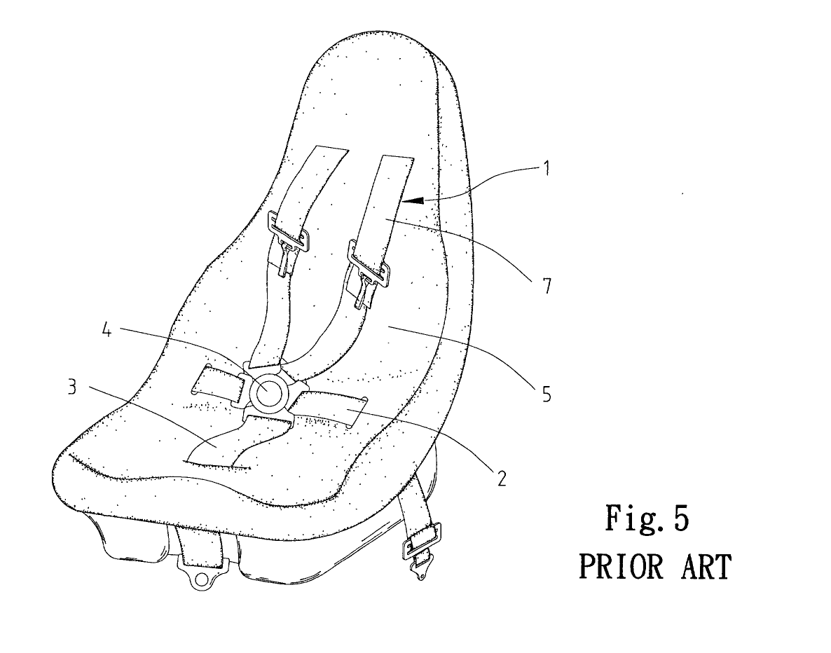

FIG. 6 is a side view of the chair and the seat belt device according to prior art;

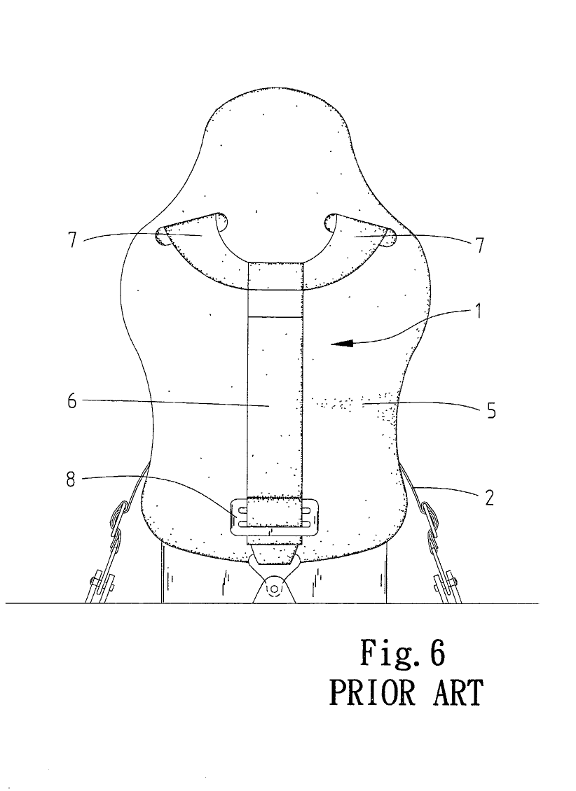

FIG. 7 is a side view of a driver tightly held onto a chair via the seat belt device according to prior art; and

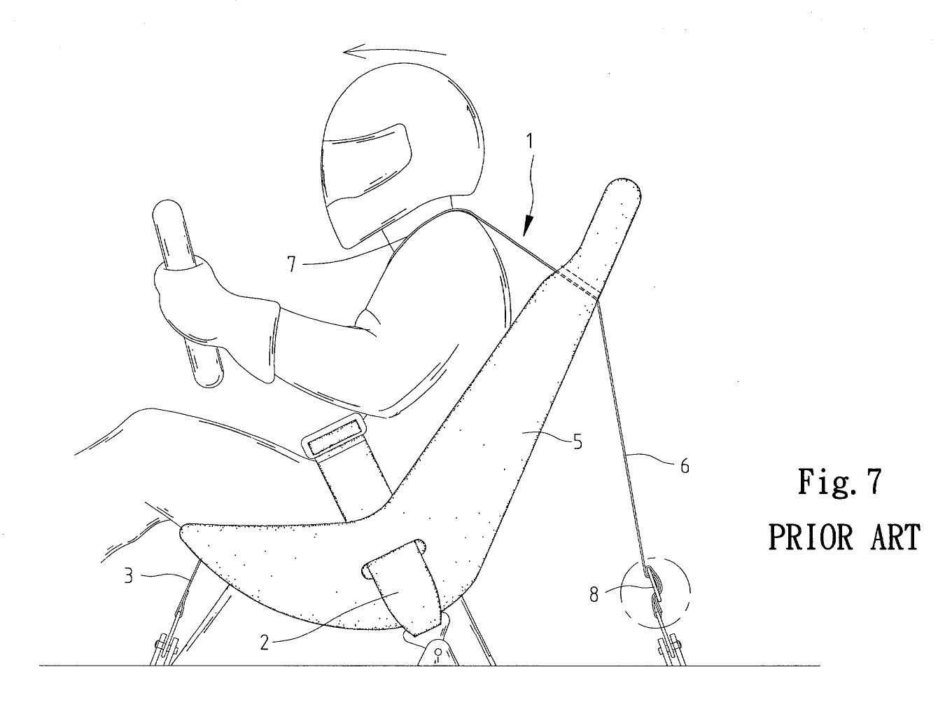

FIG. 8 is an enlarged side view of a rear belt and a length-adjusting element used in the seat belt device according to prior art.

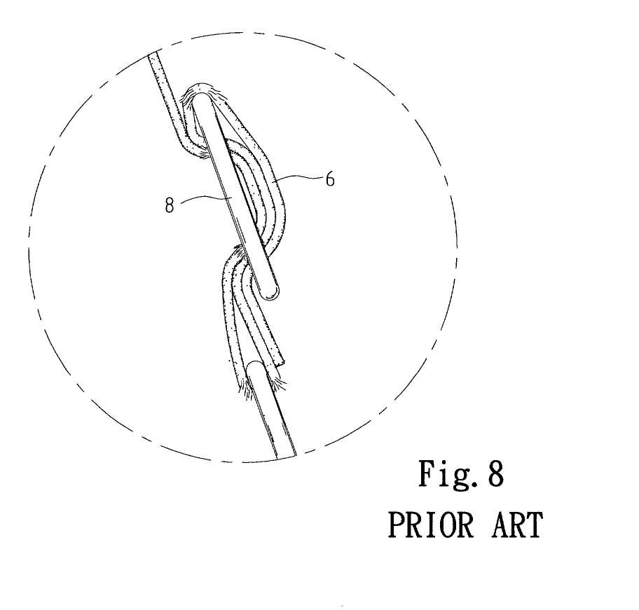

### DETAILED DESCRIPTION OF PREFERRED EMBODIMENT

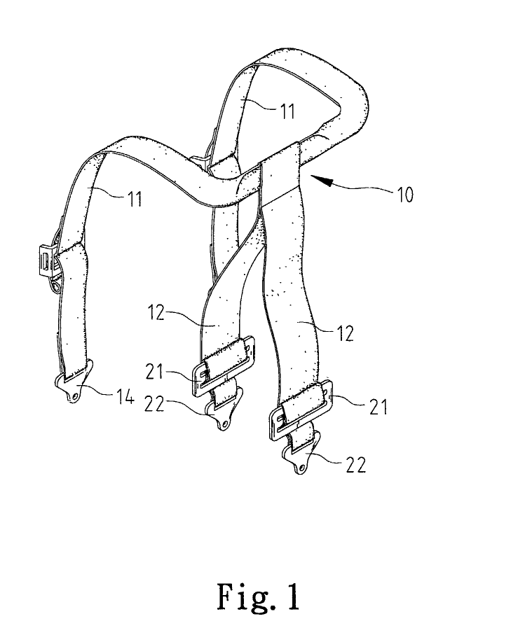

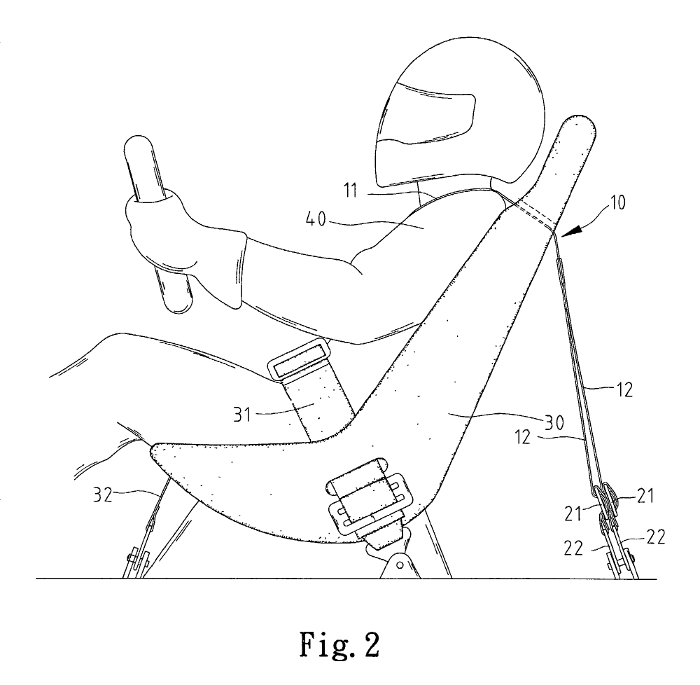

Referring to FIGS. 1 and 2, according to a first embodiment of the present invention, a seat belt device includes two west belts 31, a front belt 32, two shoulder belts 11 and two rear belts 12.

Each of the west belts 31 includes a first end and a second end. The first end of each of the west belts 31 is secured to a chassis of a car (not numbered). Each of the west belts 31 is inserted through a slot (not numbered) defined in a chair 30 of the car so that the second end thereof can be engaged with a joint such as the joint 40 described in the Related Prior Art.

The front belt 32 includes a first end and a second end. The first end of the front belt 32 is secured to the chassis. The front belt 32 is inserted through a slot (not shown) defined in the chair 5 so that the second end thereof can be engaged with the joint.

Each of the shoulder belts 11 includes a first end and a second end. The first end of each of the shoulder belts 11 is connected with the first end of the other one of the shoulder belts 11. Each of the shoulder belts 11 is inserted through a slot defined in the chair 30 so that the second end thereof can be engaged with the joint.

In the first embodiment, the shoulder belts 11 are in fact two sections of a single shoulder belt. The single shoulder belt includes two ends each inserted through a slot defined in the chair 30 so that they can be engaged with the joint.

Each of the rear belts 12 includes a first end secured to the chassis and a second end connected with the second ends of the shoulder belts 11. Each of the rear belts 12 is wound around a length-adjusting element 21 and connected with a buckle 22. Each of the buckles 22 can be secured to the chassis.

In the first embodiment, the rear belts 12 are in fact two sections of a single rear belt. The single rear belt is folded into two identical sections. The sections of the single rear belt are sewed together near a middle point, thus forming a loop through which the single shoulder belt is inserted.

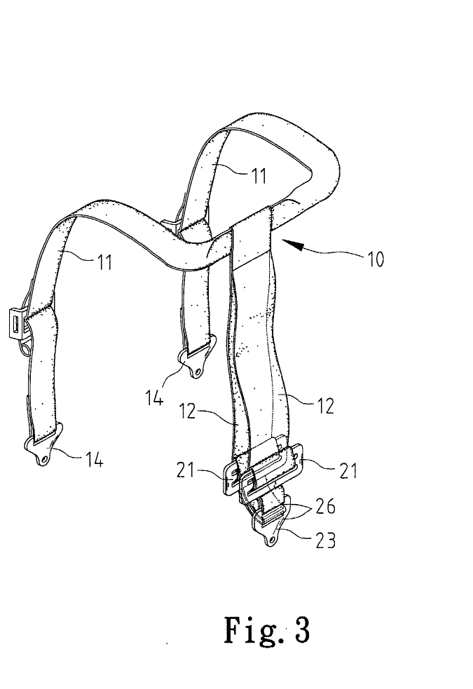

FIG. 3 shows a seat belt according to a second embodiment of the present invention. The second embodiment is identical to the first embodiment except for including only one buckle 23 instead of two buckles 22. The buckle 23 is identical to each of the buckles 22 except for defining two slots 26 instead of a single slot. The first end of one of the rear belts 12 is inserted through one of the slots 26 into connection with a portion of the same rear belt 12. The first end of the other one of the rear belts 12 is inserted through the slots 26 into connection with a portion of the same rear belt 12. The buckle 23 is secured to the chassis.

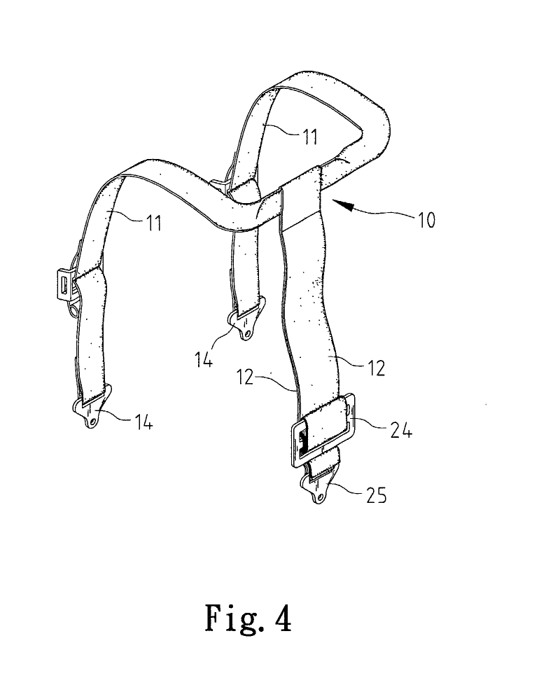

FIG. 4 shows a seat belt according to a third embodiment of the present invention. The third embodiment is identical to the first embodiment except for including only one length-adjusting element 24 instead of two length-adjusting elements 21 and for including only one buckle 25 instead of two buckles 22. The length-adjusting element 24 is identical to each of the length-adjusting elements 21 except for defining two slots (not numbered) larger than that are defined in each of the length-adjusting elements 21. The buckle 25 is identical to each of the buckles 22 except for defining a slot (not numbered) larger than that is defined in each of the buckles 22. The rear belts 12 are both inserted through the slots defined in the length-adjusting element 24 and the slot defined in the buckle 25 so that the rear belts 12 are connected to the buckle 25. The buckle 25 is secured to the chassis.

The present invention has been described through detailed illustration of the preferred embodiment. Those skilled in the art can derive many variations from the preferred embodiment without departing from the scope of the present invention. Therefore, the preferred embodiment shall not limit the scope of the present invention. The scope of the present invention is defined in the attached claims.

1. A seat belt device including:
a joint;
two west belts 31, each of the west belts 31 includes a first end secured to a chassis of a vehicle and a second end for engagement with the joint;
a front belt 32, the front belt 32 includes a first end secured to the chassis and a second end for engagement with the joint;
two shoulder belts 11, each of the shoulder belts 11 includes a first end connected with the first end of the other one of the shoulder belts 11 and a second end for engagement with the joint; and
two rear belts 12, each of the rear belts 12 includes a first end secured to the chassis and a second end connected with the second ends of the shoulder belts 11

2. The seat belt device according to claim 1 including two length-adjusting elements 21 each connected with one of the rear belts 12.

3. The seat belt device according to claim 1 including a length-adjusting element 24 connected with the rear belts 12.

4. The seat belt device according to claim 1 including two buckles 22 each connected with one of the rear belts 12 and secured to the chassis.

5. The seat belt device according to claim 1 including a buckle 23; 25 connected with the rear belts 12 and secured to the chassis.

6. The seat belt device according to claim 5 wherein the buckle 23 defines two slots 26, and the first end of one of the rear belts 12 is inserted through one of the slots 26 into connection with a portion of the same rear belt 12, and the first end of the other one of the rear belts 12 is inserted through the slots 26 into connection with a portion of the same rear belt 12.

7. The seat belt device according to claim 5 wherein the buckle 25 defines a slot for receiving the rear belts 12.

8. The seat belt device according to claim 7 including a length-adjusting element 24 connected with the rear belts 12.

9. The seat belt device according to claim 1 wherein the first end of each of the shoulder belts 11 is formed integrally with the first end of the other one of the shoulder belts 11.

10. The seat belt device according to claim 1 wherein the second end of each of the rear belts 12 is formed integrally with the second end of the other one of the rear belts 12.
